(19) United States
(12) Patent Application Publication
(10) Pub. No.: US 2006/0073730 A1
(43) Pub. Date: Apr. 6, 2006

(54) Christmas plug and socket connection cover

(76) Inventor: F. Renee Morrison, Ft. Wayne, IN (US)

Correspondence Address: BAKER & DANIELS LLP, 300 NORTH MERIDIAN STREET, SUITE 2700, INDIANAPOLIS, IN, 46204, US

(21) Appl. No.: 10/957,821

(22) Filed: Oct. 4, 2004

(51) Int. Cl. H01R 13/52

(52) U.S. Cl. 439/521

(57) ABSTRACT

The present invention includes a plug and socket connection housing having a top cover and a bottom cover pivotally coupled to the top cover, the top and bottom covers together forming an enclosure for enclosing an electrical plug and socket connection and at least one of the top and bottom covers having a Christmas design.

### TECHNICAL BACKGROUND

This invention generally relates to an electrical connector cover. More specifically, the present invention relates to an electrical connector cover with decorative features for use on special occasions.

### BACKGROUND OF THE INVENTION

Electrical plug and socket covers, housings, casings and sleeves are known in the art and have been used for years to protect the connections between mating electrical devices. The known structures, however, generally are either aesthetically unappealing or may only be used in limited settings do to their lack of aesthetic and decorative features. Further, the known plug and socket covers also require that the plug and socket connection either 1) rest on the inner bottom surface of the cover, thereby increasing the necessary length of the electrical cord, or 2) hang suspended in mid-air, in which case stress is placed on the respective cords connected to each of the plug and the socket, thereby shortening the life of the electrical cords. Both of these situations naturally increase the costs associated with maintaining the electrical connection.

### SUMMARY OF THE INVENTION

The present invention provides an electrical plug and socket cover that can be used in special settings such as Christmas holiday decorations. The present invention also prevents the plug and socket connection both from laying on the inner bottom surface of the cover and from hanging in mid-air within the cover.

In one form of the present invention, a decorative plug cover is provided, the plug cover including a housing having a top cover and a bottom cover, the bottom cover defining a cavity having an inside bottom surface; at least connecting member coupling the top cover to the bottom cover and enabling the top and the bottom covers to come together to form an enclosure suitably sized to enclose at least one electrical connection between a receptacle from a first electrical cord and a plug from a second electrical cord; and at least one electrical connection holding member extending upwardly from the inside bottom surface of the bottom cover into the enclosure for holding the receptacle and plug above the bottom surface.

In another form of the present invention, the housing includes a top cover and a bottom cover attached to the top cover and defining a cavity having a bottom surface, wherein the top and bottom covers together form an enclosure for enclosing an electrical plug and socket connection, the bottom surface including at least one plug and socket connection holding member extending vertically into the enclosure for holding the plug and socket connection above the bottom surface.

In still another form of the present invention, the inventive housing includes a top cover and a bottom cover pivotally coupled to the top cover, the top and bottom covers together forming an enclosure for enclosing an electrical plug and socket connection, and at least one of said top and bottom covers has a Christmas design.

### DESCRIPTION OF THE DRAWINGS

The above-mentioned and other features and objects of this invention, and the manner of attaining them, will become more apparent and the invention itself will be better understood by reference to the following description of an embodiment of the invention taken in conjunction with the accompanying drawings, wherein:

FIG. 1A is an illustrative front view of the inventive plug and socket connection cover having a Christmas house design;

FIG. 1B is an illustrative front view of the inventive plug and socket connection cover having a Christmas present design;

FIG. 2 is an illustrative back view of the inventive plug and socket connection cover;

FIG. 3A is an illustrative side view of a first embodiment of the inventive plug and socket connection cover;

FIG. 3B is an illustrative side view of a second embodiment of the inventive plug and socket connection cover;

FIG. 3C is an illustrative side view of a third embodiment of the inventive plug and socket connection cover;

FIG. 4A is a diagrammatic view of the inside of a plug and socket connection cover wherein one connection is displayed;

FIG. 4B is a diagrammatic view of the inside of a plug and socket connection cover wherein two connections are displayed;

FIG. 5A is an illustrative view of a first embodiment of the inner bottom surface of the bottom cover of the inventive plug and socket connection cover;

FIG. 5B is an illustrative view of a second embodiment of the inner bottom surface of the bottom cover of the inventive plug and socket connection cover;

FIG. 5C is an illustrative view of a third embodiment of the inner bottom surface of the bottom cover of the inventive plug and socket connection cover; and

FIG. 6 is a diagrammatic view of an embodiment of the plug and socket connection cover in which the socket is integrated with the cover.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention in several forms and such exemplification is not to be construed as limiting the scope of the invention in any manner.

### DESCRIPTION OF INVENTION

The embodiments disclosed below are not intended to be exhaustive or limit the invention to the precise forms disclosed in the following detailed description. Rather, the embodiments are chosen and described so that others skilled in the art may utilize their teachings.

It is often desirable during the Christmas season to decorate one's home with Christmas lights, which oftentimes run between Christmas decorations such as Christmas village decorations. Christmas village decorations, as well as many others, are suitable for decorating the mantel above a fireplace. Since Christmas lights do not have often have long electrical cords, it is often necessary to string multiple Christmas lights together by using the lights' plug and socket connectors. A problem with stringing multiple Christmas lights together, however, is that one is left with multiple plug and socket connections that are not aesthetically pleasing to look at alongside one's Christmas decorations. The use of the prior art electrical connector covers described supra do not provide a viable solution to this problem because the covers do not provide decorative designs that would allow the covers to accentuate the Christmas decorations setting.

The use of the term “decorative designs” is herein described as any feature or design used to increase the aesthetic quality of a product, as well as to recognize or provide a setting for any other holiday, event, or decorative scheme, e.g., Thanksgiving, Easter, Hanukah, birthdays, Christenings, Bat Mitzvahs, Bar Mitzvahs, baptisms, etc. The use of the term “Christmas design” herein refers to any feature or design related to the Christmas holiday, for example, a Christmas house (i.e., a house exhibiting snow, Christmas lights, a Christmas reef, or any other Christmas decoration used to decorate a home during the holiday season), a Christmas present or gift (e.g., a box wrapped with wrapping paper), a carton of egg nog, a snow person, a Christmas tree, a Christmas tree ornament, and any other decoration used during the Christmas season to invoke good feelings and holiday cheer in people. It is contemplated that both decorative and Christmas designs may either be molded into a product during manufacture or added to product after manufacture.

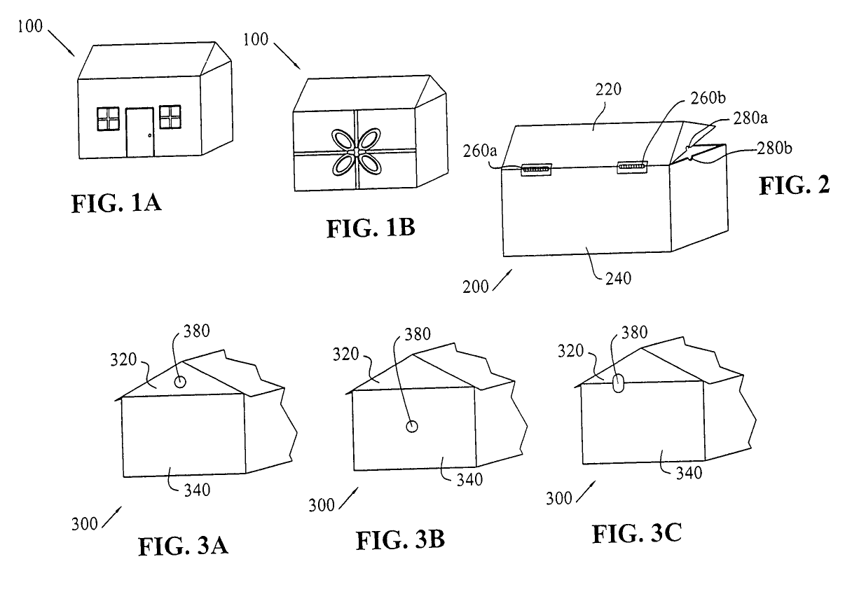

A front view of the plug and socket cover (or “cover”) of the present invention is shown in FIGS. 1A and 1B. In FIG. 1A, plug and socket cover 100 is shown having a Christmas house design. In FIG. 1B, plug and socket cover 100 is shown having a Christmas present design. Plug and socket cover 100 may be made out of any durable material, including, but not limited to, plastic and metal. In exemplary embodiments of the present invention, cover 100 is made from a non-flammable material.

A back view of the plug and socket cover is shown in FIG. 2. Cover 200 includes top portion 220 connected to bottom portion 240 by connecting members 260a, 260b. In one embodiment of the plug and socket cover, connecting members 260a, 260b may include seams of flexible material (e.g., plastic or cardboard) that connect top and bottom portions 220, 240. In another embodiment, connecting members 260a, 260b may include hinges. Either a single hinge or three (3) or more hinges may be used to connect top and bottom portions 220, 240. Hinges 260a, 260b enable cover 200 to be in an open and closed state and may be made from a plastic or a metal.

In an embodiment of the present invention, each of top portion 220 and bottom portion 240 contain an opening 280a, 280b that form aperture 280 when plug and socket cover 200 is closed. In alternative embodiments of cover 200 shown in FIG. 3, aperture 380 may be formed in top portion 320 (FIG. 3A), in bottom portion 340 (FIG. 3B) or, as described above, in top and bottom portions 320, 340 when brought together (FIG. 3C). Aperture 380 is located on both the side of cover 300 shown in Figs. A, B and C, as well as the sides of cover 300 opposite to those sides shown (not shown).

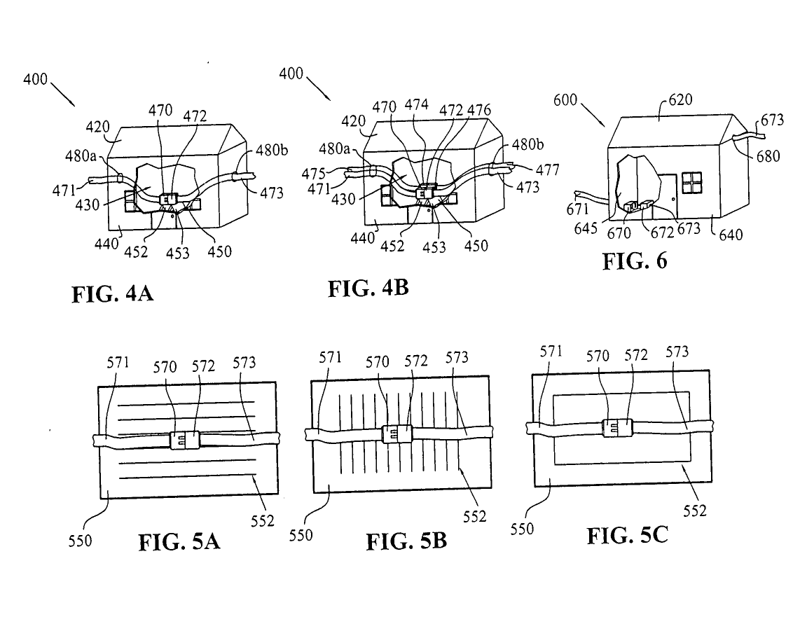

An internal view of the plug and socket connection cover of the present invention is exhibited in FIG. 4. In FIG. 4A, cover 400 includes top portion 420 and bottom portion 440. Bottom portion 440 defines a cavity, and as shown through the cut-out of cover 400, when top portion 420 and bottom portion 440 come together, enclosure 430 is created. Enclosure 430 is suitably sized to accommodate one or more electrical connections consisting of socket 470 and plug 472. Electrical cord 471 is connected to socket 470 and extends through aperture 480 outside of cover 400. Similarly, electrical cord 473 is connected to plug 472 and extends out of cover 400 via aperture 480b.

The cavity defined in bottom portion 440 has bottom surface 450. Bottom surface 450 includes one or more plug and socket connection holding members 452, 453 that hold plug 472 and socket 470 above bottom surface 450. In one embodiment of the present invention, holding members 452, 453 are protruded from bottom surface 450 and made from the same material as bottom portion 440. In other embodiments of the present invention, holding members 452, 453 may be made from a different material and attached to bottom surface 450 by use of an adhesive, tape or a latch and hook mechanism. FIG. 4B displays cover 400 forming enclosure 430, which is suitably sized to accommodate two (2) plug and socket connections, and apertures 480a, 480b are suitably sized to surround two (e) electrical cords 471, 475 and 473, 477, respectively, which extend out of cover 400.

As described above, bottom surface 450 of the cavity defined in bottom portion 440 may include one (1) or more plug and socket connection holding members. FIGS. 5A, 5B and 5C illustrate different ways in which the holding members may be oriented. In FIG. 5A, plug 572 and socket 570 are laying upon multiple holding members 552, which are both positioned in parallel with one another and parallel with the plug and socket connection. In FIG. 5B, the plug and socket connection is being held by multiple holding members 552, and hold members 552 are positioned in parallel with one another and perpendicular to the plug and socket connection. In another embodiment of the present invention shown in FIG. 5C, the plug and socket connection is being held by a single holder member 552, which is a raised surface from bottom surface 550.

Another embodiment of the inventive plug and socket connection cover is illustrated in FIG. 6. Plug and socket connection cover 600 includes top portion 620 attached to bottom portion 640. Bottom portion 640 includes inner wall 645 in which electrical socket 670 is integrated. In other embodiments of the plug and socket cover 600, socket 670 may be integrated into bottom portion 640 in other positions or integrated in top portion 620 as well. Electrical cord 671 is attached to socket 670, and socket 670 receives plug 672.

In the above described embodiments of the Christmas plug and socket connection cover, the dimensions of the cover is approximately 12.7 centimeters (cm) by 15.5 cm by 12.7 cm. In different embodiments of the inventive cover, however, these dimensions may vary to accommodate multiple plug and socket connections.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A decorative plug cover comprising:
a housing having a top cover and a bottom cover, the bottom cover defining a cavity and having an inside bottom surface;
at least one connecting member coupling the top cover to the bottom cover and enabling the top and the bottom covers to come together to form an enclosure suitably sized to enclose at least one electrical connection between a receptacle from a first electrical cord and a plug from a second electrical cord; and
at least one electrical connection holding member extending upwardly from the inside bottom surface of the bottom cover into the enclosure and holding the receptacle and plug above the bottom surface.

2. The plug cover of claim 1 wherein the enclosure defines a first wall and a second wall opposite the first wall, each of the walls defining an aperture suitably sized to surround at least one electrical cord.

3. The plug cover of claim 2 wherein said at least one electrical connection holding member includes multiple projections positioned horizontally across the bottom surface between the first and second walls and parallel therewith.

4. The plug cover of claim 2 wherein the enclosure further defines third and fourth walls perpendicular to the first and second walls.

5. The plug cover of claim 4 wherein said at least one electrical connection holding member includes multiple projections positioned horizontally across the bottom surface between the third and fourth walls and parallel therewith.

6. The plug cover of claim 1 wherein an electrical socket is integrated with said housing.

7. The plug cover of claim 6 wherein said housing includes at least one of a Christmas house and a Christmas gift decorative design.

8. The plug cover of claim 2 wherein the enclosure is suitably sized to enclose multiple electrical connections between multiple receptacles and multiple plugs, each receptacle and plug having an electrical cord associated therewith.

9. A housing comprising:
a top cover; and
a bottom cover attached to said top cover, defining a cavity, and having a bottom surface, wherein said top and bottom covers together form an enclosure for enclosing an electrical plug and socket connection, the bottom surface including at least one plug and socket connection holding member extending vertically into the enclosure and holding the plug and socket connection above the bottom surface.

10. The housing of claim 9 wherein the top and bottom covers each define at least one groove, wherein the grooves together form an aperture suitably sized to surround at least one electrical cord associated with the plug and socket connection when the top and bottom covers are brought together.

11. The housing of claim 9 wherein at least one of the top and bottom covers define at least one aperture suitably sized to surround at least one electrical cord associated with the plug and socket connection.

12. The housing of claim 9 wherein at least one of said top and bottom covers includes one of a Christmas house and a wrapped Christmas gift decorative design.

13. The housing of claim 9 wherein an electrical socket is integrated into one of said top and bottom covers.

14. A decorative housing comprising:
a top cover; and
a bottom cover having an inside bottom surface and pivotally coupled to said top cover, said top and bottom covers together forming an enclosure for enclosing an electrical plug and socket connection, and at least one of said top and bottom covers has a decorative Christmas design, and
at least one electrical connection holding member extending upwardly from the inside bottom surface of the bottom cover into the enclosure and holding the plug and socket connection above the bottom surface.

15. The housing of claim 14 wherein said bottom cover defines a cavity with a bottom surface having at least one plug and socket connection member extending vertically into the enclosure for holding the plug and socket above the bottom surface.

16. The housing of claim 14 wherein said at least plug and socket connection holding member includes multiple protrusions positioned horizontally across the bottom surface of said bottom cover.

17. The housing of claim 14 wherein said top and bottom covers together define at least one aperture suitably sized to surround at least one electrical cord associated with the plug and socket connection.

18. The housing of claim 14 wherein the decorative Christmas design includes one of a Christmas house and a wrapped Christmas gift design.

19. The housing of claim 14 wherein an electrical socket is integrated within one of said top and bottom covers.

20. The housing of claim 17 wherein said top and bottom covers together define a first and a second aperture, the first aperture suitably sized to surround a first electrical cord associated with a plug and the second aperture suitably sized to surround a second electrical cord associated with a socket.
